(19) United States
(12) Patent Application Publication
(10) Pub. No.: US 2007/0155338 A1
(43) Pub. Date: Jul. 5, 2007

(54) Apparatus and method for transmitting data using adaptive modulation and coding in mobile communication system having a relay station

(75) Inventors: Sung-Kwon Hong, Seoul (KR); Do-Young Kim, Yongin-si (KR); Dong-Seek Park, Yongin-si (KR); Seung-Hoon Park, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/649,185

(22) Filed: Jan. 3, 2007

(30) Foreign Application Priority Data
Jan. 3, 2006 (KR) 2006-0000654

(51) Int. Cl. H04B 7/00

(52) U.S. Cl. 455/69; 341/143; 455/11.1; 455/63.1

(57) ABSTRACT

Provided are an apparatus and method for transmitting data using an Adaptive Modulation and Coding (AMC) scheme in a mobile communication system with a Relay Station (RS). A relay indicator value is received indicating a strength of a downlink signal transmitted to a destination through a relay path including the RS and a direct indicator value indicating a strength of an downlink signal directly transmitted to the destination via a direct path without passing through the RS. Modulation and Coding Scheme (MCS) levels are determined using the relay and direct indicator values for both the relay and direct paths. Bandwidth efficiencies are found in correspondence with the MCS levels and are compared depending on whether the relay path or the direct path is used. A path resulting in a higher bandwidth efficiency is selected to generate a data frame having a structure corresponding to the selected path. The data frame is transmitted to the destination or the RS.

### PRIORITY

This application claims priority under 35 U.S.C. § 119 to an application filed in the Korean Intellectual Property Office on Jan. 3, 2006 and assigned Serial No. 2006-654, the contents of which are incorporated herein by reference.

### BACKGROUND OF THE INVENTION

1. Field of the Invention

The present invention relates generally to a mobile communication system with a Relay Station (RS), and more particularly, to an apparatus and method for transmitting data using an Adaptive Modulation and Coding (AMC) scheme in a mobile communication system having an RS.

2. Description of the Related Art

Extensive research has been conducted to provide high-speed, high-capacity Quality of Services (QoS) in the next generation (4^{th} generation, 4G) communication system.

Data is transferred at a rate of about 20 Mbps to 50 Mbps in Wireless Local Area Network (WLAN) and Wireless Metropolitan Area Network (WMAN) communication systems. That is, a WMAN communication system can provide high-speed and high-capacity communication services over a large service area. However, the mobility of a Subscriber Station (SS) is not considered in the WMAN communication system. Therefore, extensive research has been actively conducted to develop high-speed and high-capacity 4G WLAN and WMAN communication systems supporting the mobility of an SS and providing reliable QoS.

An Institute of Electrical and Electronics Engineering (IEEE) 802.16a communication system uses Orthogonal Frequency Division Multiplexing (OFDM) and Orthogonal Frequency Division Multiple Access (OFDMA) communication schemes so as to support broadband transmission networking through a physical channel of a WMAN communication system. An IEEE 802.16a communication system can transmit large amounts of data at a high rate by sending physical channel signals using a plurality of sub-carriers since the IEEE 802.16a communication system is designed to apply an OFDM/OFDMA communication scheme to a WMAN communication system.

In the IEEE 802.16a communication system, stationary SSs (i.e., SSs in a stationary state where the mobility of SSs is not considered) and SSs moving in a single cell are supported. However, in an IEEE 802.16e communication system, the mobility of SSs is supported unlike the IEEE 802.16a communication system. That is, the IEEE 802.16e communication system is a cellular communication system supporting a multi cell communication scheme. Hereinafter, when an SS is movable, the SS will be referred to as a Mobile Subscriber Station (MSS). That is, the 4G-communication system progresses in the form of a cellular communication system while supporting high-speed and high-capacity data transmission such as in the IEEE 802.16e system.

Meanwhile, relay communication schemes have been actively studied for a wireless network communication system such as an IEEE 802.11 communication system, and an ad-hoc or multi-hop network communication scheme has been primarily studied as a relay communication scheme. In a relay communication scheme, when an MSS (e.g., a first MSS) cannot communicate with a first Base station (BS) since a communication channel between the first MSS and the first BS is in a poor state, another MSS (for example, a second MSS) or BS (for example, a second BS) can relay signals between the first MSS and the first BS so as to allow the first MSS to communicate with the first BS. For example, this relay communication scheme can also be used to provide improved communication between the first MSS and the first BS.

Accordingly, when an MSS is in a poor-channel region such as a cell boundary region or a region surrounded by obstacles (or many MSSs assembled in a relatively small region such as a hot-spot region), the relay communication scheme can be used for the 4G-communication system to provide a predetermined QoS in consideration of total traffic (hereinafter throughput) in a cell. That is, since the 4G-communication system is designed to provide high-speed and high-capacity data transmission services at the same level as the existing wired communication system, the use of the relay communication scheme in the 4G-communication system has been actively studied to allow the 4G-communication system to provide high-speed, high-capacity data transmission services in a wireless channel environment varying according to the motion of an MSS and surrounding conditions.

For example, in the related art or the present invention, a BS can be one of source stations, and a Mobile Station (MS) can be one of destination stations. Alternatively, the BS and MS can be other types of source and destination stations.

FIG. 1 illustrates a conventional mobile communication system using an RS.

Referring to FIG. 1, an MS 110, which is located inside a coverage area 101 of a BS 100, communicates directly with the BS 100. An MS 120, which is located outside the coverage area 101 and thus has poor channel conditions, communicates indirectly with the BS 100 through an RS 130.

That is, when an MS communicates directly with the BS 100 but has poor channel conditions due to being located outside the BS coverage area 101 or in a shadow area surrounded by obstacles such as buildings, the MS can communicate indirectly with the BS 100 through the RS according to a multi-hop relay scheme. Using the multi-hop relay scheme, the BS 100 can provide a high-rate data channel in a cell boundary region with a poor channel condition and thus can expand a cell service area (i.e., the coverage area 101).

A data frame structure for the mobile communication system using a relay station may includes uplink and downlink regions (sections) for a relay station as well as uplink and downlink regions for an MS. However, communication resources may be wasted since such a data structure is used when an MS communicates directly with a BS without an intervening RS.

Meanwhile, in an adaptive modulation communication scheme, data is transmitted in different modulation manners according to channel conditions so as to improve data transmission rate and quality. For example, a high-order modulation is used to increase a data transmission rate when a channel condition is good, and a low-order modulation is used to improve data transmission quality when channel condition is poor. An adaptive modulation scheme combined with coding is called an Adaptive Modulation and Coding (AMC). In the AMC, several communication levels are defined using a plurality of coding rates and modulation orders, and one of the levels is selected according to communication conditions. A group of such communication levels is called a Modulation and Coding Scheme (MCS) set, and each communication level is called an MCS level.

Channel information should be obtained from a transmitter and a receiver, and information about a feedback channel from the receiver to the transmitter should be obtained so as to use the AMC. For example, in a Frequency Division Duplexing (FDD) scheme, such channel information is transmitted with a delay, and thus the AMC cannot be performed under optimal conditions.

In an AMC scheme, an MCS level can be determined as follows. A transmitter has information about the relationship between performance and MCS level. One MCS level that results in the maximum transmission rate is selected from MCS levels that satisfy a desired Frame Error Rate (FER) level in a communication system designed to use feedback channel information such as a Signal to Interference and Noise Ratio (SINR). The method of selecting an MCS level can vary based on system requirements. That is, when it is important to maximize the throughput of a system, an MCS level resulting in a higher transmission rate than a reference MCS level can be selected even though the FER increases to some degree. However, when it is important to decrease the FER in a system or service, an MCS level having a better coding strength (less coding rate) than a reference MCS level can be selected even though the transmission rate decreases to some degree.

FIG. 2 is a graph illustrating a method of selecting an MCS level using an AMC scheme.

Referring to FIG. 2, MCS levels 3 and 4 can satisfy a reference FER of 0.01, and the MCS level 3 is selected in consideration of the possibility of an outage.

Thus, there is needed an apparatus and method for selecting an appropriate frame structure so as to efficiently use communication resources and adjust transmission rate based on channel conditions in a mobile communication system having a relay station.

### SUMMARY OF THE INVENTION

An object of the present invention is to substantially solve at least the above problems and/or disadvantages and to provide at least the advantages below. Accordingly, an object of the present invention is to provide an apparatus and method for transmitting data using an AMC scheme in a mobile communication system having an RS.

Another object of the present invention is to provide an apparatus and method for determining whether an RS is used depending on channel conditions when data is transmitted to an MS using an AMC scheme in a mobile communication system having an RS.

A further another object of the present invention is to provide an apparatus and method for determining whether an RS is used depending on channel conditions and generating a data frame having a structure corresponding to the determination when data is transmitted to an MS using an AMC scheme in a mobile communication system having an RS.

According to the present invention, there is provided a source apparatus for transmitting data using an AMC scheme in a mobile communication system with an RS, the source apparatus including a controller for controlling generation of a frame structure, a frame format constructor controlled by the controller so as to receive transmission data and generate a data frame based on the frame structure, and a Radio Frequency (RF) transmitter for transmitting the data frame received from the frame format constructor to a destination or the RS, wherein the controller receives a relay indicator value indicating a strength of a downlink signal transmitted to the destination through a relay path including the RS and a direct indicator value indicating a strength of a downlink signal directly transmitted to the destination via a direct path without passing through the RS so as to determine MCS levels using the relay and direct indicator values for both the relay and direct paths, the controller finding bandwidth efficiencies corresponding to the MCS levels and comparing the bandwidth efficiencies so as to select a path resulting in a higher bandwidth efficiency from the relay and direct paths and allow the frame structure to be generated in correspondence with the selected path.

According to the present invention, there is provided a source apparatus for transmitting data using an AMC scheme in a mobile communication system with an RS, the source apparatus including a controller for controlling generation of a frame structure, a frame format constructor controlled by the controller so as to receive transmission data and generate a data frame based on the frame structure, and an RF transmitter for transmitting the data frame received from the frame format constructor to a destination or the RS, wherein the controller measures a relay indicator value indicating a strength of an uplink signal transmitted to the source apparatus through a relay path including the RS and a direct indicator value indicating a strength of an uplink signal directly transmitted to the source apparatus via a direct path without passing through the RS so as to determine MCS levels using the relay and direct indicator values for both the relay and direct paths, the controller finding bandwidth efficiencies corresponding to the MCS levels and comparing the bandwidth efficiencies so as to select a path resulting in a higher bandwidth efficiency from the relay and direct paths and allow the frame structure to be generated in correspondence with the selected path.

According to the present invention, there is provided a method for transmitting data from a source apparatus using an AMC scheme in a mobile communication system with an RS, the method including receiving a relay indicator value indicating a strength of an downlink signal transmitted to a destination through a relay path including the RS and a direct indicator value indicating a strength of an downlink signal directly transmitted to the destination via a direct path without passing through the RS, determining MCS levels using the relay and direct indicator values for both the relay and direct paths, finding bandwidth efficiencies corresponding to the MCS levels, comparing the bandwidth efficiencies depending on whether the relay path or the direct path is used, selecting a path resulting in a higher bandwidth efficiency from the relay and direct paths so as to generate a data frame having a structure corresponding to the selected path, and transmitting the data frame to the destination or the RS.

According to the present invention, there is provided a method for transmitting data using an AMC scheme in a mobile communication system with an RS, the method including measuring a relay indicator value indicating a strength of an uplink signal transmitted to a source apparatus through a relay path including the RS and a direct indicator value indicating a strength of an uplink signal directly transmitted to the source apparatus via a direct path without passing through the RS, determining MCS levels using the relay and direct indicator values for both the relay and direct paths, finding bandwidth efficiencies corresponding to the MCS levels, comparing the bandwidth efficiencies depending on whether the relay path or the direct path is used, selecting a path resulting in a higher bandwidth efficiency from the relay and direct paths so as to generate a data frame having a structure corresponding to the selected path, and transmitting the data frame to a destination or the RS.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional mobile communication system using a relay station;

FIG. 2 illustrates a conventional method of selecting an MCS level using an AMC scheme;

FIG. 3 illustrates a BS of a mobile communication system having an RS and using an AMC scheme according to the present invention;

FIG. 4 explains a method for generating a data frame using an AMC scheme in a BS of a mobile communication system having an RS according to the present invention;

FIG. 5A illustrates a data frame generated by a BS using an AMC scheme so as to transmit the data frame without using an RS in a mobile communication system having an RS according to the present invention; and

FIG. 5B illustrates a data frame generated by a BS using an-AMC scheme so as to transmit the data frame through an RS in a mobile communication system having an RS according to the present invention.

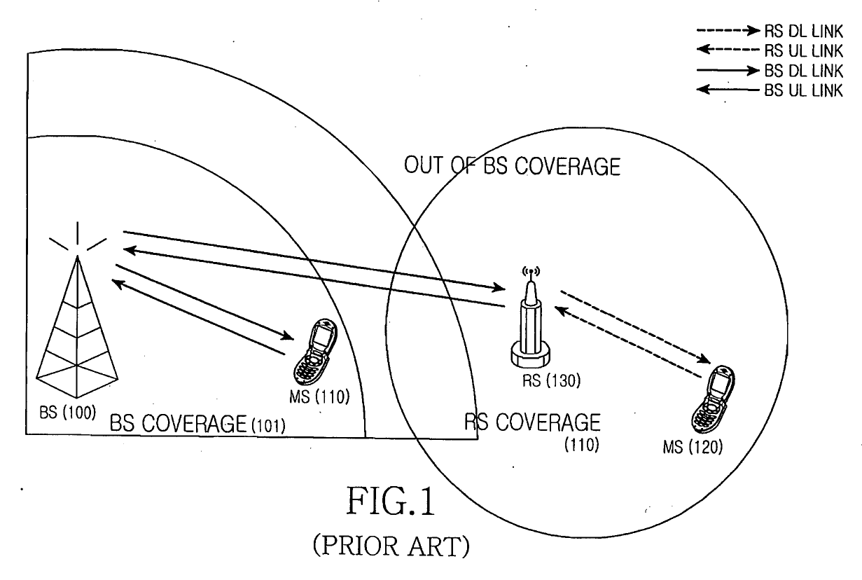

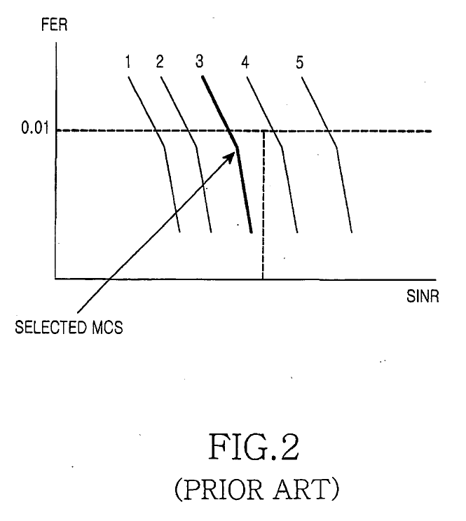

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

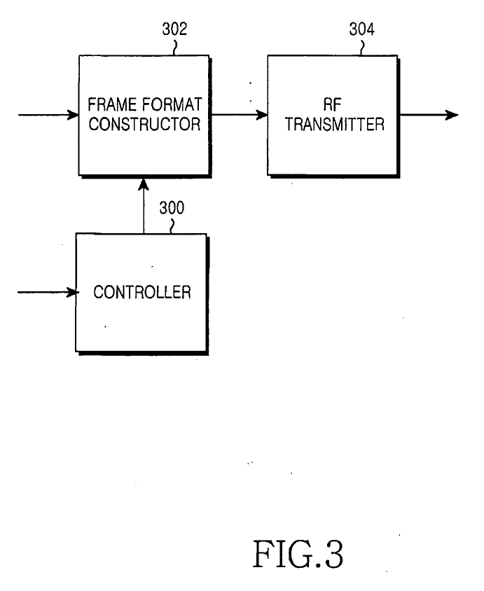

Hereinafter, an apparatus and method for transmitting data using AMC in a mobile communication system having an RS will now be described with reference to FIGS. 3 through 5 according to the present invention.

FIG. 3 illustrates a BS of a mobile communication system having an RS and using an AMC scheme according to the present invention.

Referring to FIG. 3, the BS includes a controller 300, a frame format constructor 302, and an RF transmitter 304.

The controller 300 receives a feedback value (a Signal to Interference and Noise Ratio, SINR) directly from an MS with respect to a downlink signal sent to the MS and receives an SINR indirectly from the MS through an RS with respect to a downlink signal sent to the MS. Alternatively, the controller 300 measures an SINR from an uplink signal received directly from the MS and measures an SINR from an uplink signal received indirectly from the MS through the RS. The controller 300 uses the SINRs of the uplink or downlink signals so as to determine MCS,levels using performance curves for when the RS is used and when the RS is not used. The controller 300 finds bandwidth efficiencies corresponding to the respective MCS levels. The controller 300 compares the bandwidth efficiencies for when the RS is used to when the RS is not used. Then, a frame suitable for a route resulting in a higher bandwidth efficiency is generated under the control of the controller 300.

Meanwhile, instead of receiving the feedback values or the SINRs with respect to the downlink signals so as to compare the bandwidth efficiencies depending on whether the RS is used, the controller 300 can receive MCS level values.

Furthermore, the performance curves used for determining the MCS levels vary depending on whether the RS is used, and thus the bandwidth efficiencies corresponding to the MCS levels vary depending on whether the RS is used.

That is, the controller 300 determines different MCS levels depending on whether the RS is used and finds bandwidth efficiencies corresponding to the determined MCS levels. Then, the controller 300 compares the bandwidth efficiencies so as to compare performances depending on whether the RS is used.

The frame format constructor 302 operates under the control of the controller 300 to receive transmission data and generate a data frame using the received data according to a frame structure selected by the controller 300. Then, the frame format constructor 302 sends the data frame to the RF transmitter 304.

The RF transmitter 304 transmits the data frame received from the frame format constructor 302 to an RS or an MS.

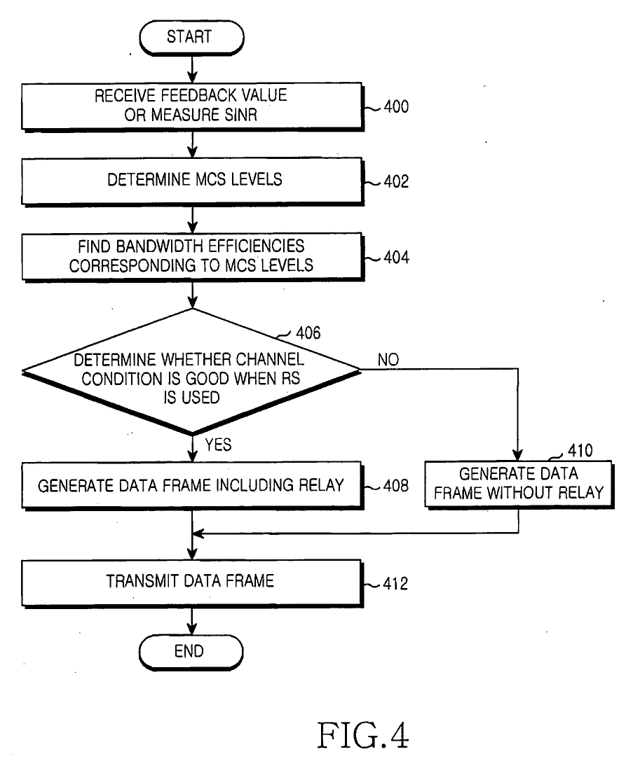

FIG. 4 explains a method for generating a data frame using an AMC scheme in a BS of a mobile communication system having an RS according to the present invention.

Referring to FIG. 4, in step 400, a BS of a mobile communication system receives an SINR directly from an MS with respect to a downlink signal sent to the MS and receives an SINR indirectly from the MS through an RS with respect to a downlink signal sent to the MS, or the BS measures an SIR from an uplink signal received directly from the MS and an SINR from an uplink signal received indirectly from the MS through the RS. In step 402, the BS determines MCS levels for the uplink signals or the downlink signals depending on whether the signals are relayed by the RS. In step 404, the BS finds bandwidth efficiencies corresponding to the respective MCS levels depending on whether the RS is used. In step 406, the BS compares the bandwidth efficiencies for when the RS is used and when the RS is not used so as to determine which case has better bandwidth efficiency.

When the bandwidth efficiency is better when the RS is used as opposed to when the RS is not used, the procedure goes to step 408 where the BS generates a data frame for the case where the RS is used. Then, the BS transmits the data frame in step 412.

When the bandwidth efficiency is not better when the RS is used as opposed to when the RS is not used, the procedure goes to step 410 where the BS generates a data frame for when the RS is not used. Then, the BS transmits the data frame in step 412.

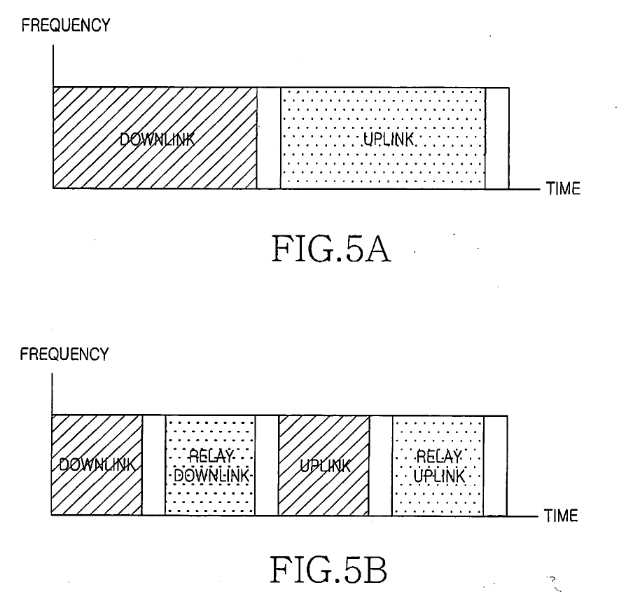

FIG. 5A illustrates a data frame generated by an BS using an AMC scheme so as to transmit the data frame without using an RS in a mobile communication system having an RS according to the present invention.

FIG. 5B illustrates a data frame generated by an BS using an AMC scheme so as to transmit the data frame through an RS in a mobile communication system having an RS according to the present invention.

As described above, according to the present invention, data is transmitted using an AMC scheme in a mobile communication system having an RS. The apparatus includes the controller, the frame format constructor and the RF transmitter. The controller receives an SINR directly from an MS with respect to a downlink signal sent to the MS and receives an SINR indirectly from the MS through an RS with respect to a downlink signal sent to the MS. Alternatively, the controller measures an SINR from an uplink signal received directly from the MS and measures an SINR from an uplink signal received indirectly from the MS through the RS. The controller uses the SINRs of the uplink or downlink signals so as to compare data transmission performances depending on whether the RS is used. Then, a frame suitable for a route resulting in a higher bandwidth efficiency is generated under the control of the controller. The frame format constructor operates under the control of the controller to receive transmission data and generate a data frame using the received data according to a frame structure selected by the controller. Then, the frame format constructor sends the data frame to the RF transmitter, which transmits the data frame received from the frame format constructor to the RS or the MS. Therefore, according to the present invention, communication resources can be saved, and a transmission rate can be adjusted depending on channel conditions since a frame structure can be selected depending on whether an RS is used.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A source apparatus for transmitting data using an Adaptive Modulation and Coding (AMC) scheme in a mobile communication system with a Relay Station (RS), the source apparatus comprising:
a controller for controlling generation of a frame structure;
a frame format constructor for generating a data frame based on the frame structure; and
a Radio Frequency (RF) transmitter for transmitting the data frame received from the frame format constructor to a destination or the RS,
wherein the controller receives a relay indicator value indicating a strength of a signal transmitted to the destination through a relay path including the RS and a direct indicator value indicating a strength of a signal directly transmitted to the destination via a direct path without passing through the RS so as to determine Modulation and Coding Scheme (MCS) levels using the relay and direct indicator values for both the relay and direct paths, the controller finding bandwidth efficiencies corresponding to the MCS levels and comparing the bandwidth efficiencies so as to select a path resulting in a higher bandwidth efficiency from the relay and direct paths and allow the frame structure to be generated in correspondence with the selected path.

2. The source apparatus of claim 1, wherein the frame structure comprises a direct uplink/downlink region for communication with the destination when the direct path is selected, and a relay uplink/downlink region for communication with the RS when the relay path is selected.

3. The source apparatus of claim 2, wherein the source apparatus is a Base Station (BS), and the destination is a Mobile Station (MS).

4. The source apparatus of claim 1, wherein the relay and direct indicator values are Signal to Interference and Noise Ratios (SINRs).

5. A source apparatus for transmitting data using an AMC scheme in a mobile communication system with an RS, the source apparatus comprising:
a controller for controlling generation of a frame structure;
a frame format constructor for generating a data frame based on the frame structure; and
an RF transmitter for transmitting the data frame received from the frame format constructor to a destination or the RS,
wherein the controller measures a relay indicator value indicating a strength of a signal transmitted to the source apparatus through a relay path including the RS and a direct indicator value indicating a strength of a signal directly transmitted to the source apparatus via a direct path without passing through the RS so as to determine MCS levels using the relay and direct indicator values for both the relay and direct paths, the controller finding bandwidth efficiencies corresponding to the MCS levels and comparing the bandwidth efficiencies so as to select a path resulting in a higher bandwidth efficiency from the relay and direct paths and allow the frame structure to be generated in correspondence with the selected path.

6. The source apparatus of claim 5, wherein the frame structure comprises a direct uplink/downlink region for communication with the destination when the direct path is selected, and a relay uplink/downlink region for communication with the RS when the relay path is selected.

7. The source apparatus of claim 6, wherein the source apparatus is a Base Station (BS), and the destination is a Mobile Station (MS).

8. The source apparatus of claim 5, wherein the relay and direct indicator values are Signal to Interference and Noise Ratios (SINRs).

9. A method for transmitting data from a source apparatus using an Adaptive Modulation and Coding (AMC) scheme in a mobile communication system with a Relay Station (RS), the method comprising the steps of:
receiving a relay indicator value indicating a strength of a signal transmitted to a destination through a relay path including the RS and a direct indicator value indicating a strength of a signal directly transmitted to the destination via a direct path without passing through the RS;
determining Modulation and Coding Scheme (MCS) levels using the relay and direct indicator values for both the relay and direct paths;
finding bandwidth efficiencies corresponding to the MCS levels;
comparing the bandwidth efficiencies depending on whether the relay path or the direct path is used;
selecting a path resulting in a higher bandwidth efficiency from the relay and direct paths so as to generate a data frame having a structure corresponding to the selected path; and
transmitting the data frame to the destination or the RS.

10. The method of claim 9, wherein the frame structure comprises an direct uplink/downlink region for communication with the destination when the direct path is selected, and a relay uplink/downlink region for communication with the RS when the relay path is selected.

11. The method of claim 10, wherein the source apparatus is a Base Station (BS), and the destination is a Mobile Station (MS).

12. The method of claim 9, wherein the relay and direct indicator values are Signal to Interference and Noise Ratios (SINRs).

13. A method for transmitting data from a source apparatus using an Adaptive Modulation and Coding (AMC) scheme in a mobile communication system with a Relay Station (RS), the method comprising the steps of:
measuring a relay indicator value indicating a strength of a signal transmitted to a source apparatus through a relay path including the RS and a direct indicator value indicating a strength of a signal directly transmitted to the source apparatus via a direct path without passing through the RS;
determining Modulation and Coding Scheme (MCS) levels using the relay and direct indicator values for both the relay and direct paths;
finding bandwidth efficiencies corresponding to the MCS levels;
comparing the bandwidth efficiencies depending on whether the relay path or the direct path is used;
selecting a path resulting in a higher bandwidth efficiency from the relay and direct paths so as to generate a data frame having a structure corresponding to the selected path; and
transmitting the data frame to a destination or the RS.

14. The method of claim 13, wherein the frame structure comprises an direct uplink/downlink region for communication with the destination when the direct path is selected, and a relay uplink/downlink region for communication with the RS when the relay path is selected.

15. The method of claim 14, wherein the source apparatus is a Base Station (BS), and the destination is a Mobile Station (MS).

16. The method of claim 13, wherein the relay and direct indicator values are Signal to Interference and Noise Ratios (SINRs).

17. A source apparatus for transmitting data in a mobile communication system having a Relay Station (RS), the source apparatus comprising:
means for comparing a strength of a signal transmitted to the destination through a relay path including the RS and a strength of a signal directly transmitted to the destination via a direct path without passing through the RS and selecting a path between the relay path and the direct path.

18. The source apparatus of claim 17, wherein the means further determines a Modulation and Coding Scheme (MCS) level using the strength of the signal in the selected path.

19. The source apparatus of claim 18, further comprising means for generating a data frame according to the determined MCS level.

20. The source apparatus of claim 18, further comprising a Radio Frequency (RF) transmitter for transmitting the data frame to a destination or the RS.

21. A method for transmitting data from a source apparatus in a mobile communication system having a Relay Station (RS), the method comprising the steps of:
comparing a strength of a signal transmitted to a destination through a relay path including the RS and a strength of a signal directly transmitted to the destination via a direct path without passing through the RS;
selecting a path resulting in a higher bandwidth efficiency between the relay and direct paths so as to generate a data frame having a structure corresponding to the selected path; and
transmitting the data frame to the destination or the RS.

22. A method for transmitting data from a source apparatus in a mobile communication system with a Relay Station (RS), the method comprising the steps of:
measuring a strength of a signal transmitted to a source apparatus through a relay path including the RS and a strength of a signal directly transmitted to the source apparatus via a direct path without passing through the RS;
selecting a path resulting in a higher bandwidth efficiency from the relay and direct paths so as to generate a data frame having a structure corresponding to the selected path; and
transmitting the data frame to a destination or the RS.
